(19) United States
(12) Patent Application Publication
(10) Pub. No.: US 2024/0211526 A1
(43) Pub. Date: Jun. 27, 2024

(54) INFORMATION TRANSMISSION METHOD, SHARING END, SERVER AND ELECTRONIC APPARATUS

(71) Applicant: Beijing Zitiao Network Technology Co., Ltd., Beijing (CN)

(72) Inventors: Zhou YU, Beijing (CN); Lin ZHANG, Beijing (CN); Yibin GAO, Beijing (CN)

(21) Appl. No.: 18/395,364

(22) Filed: Dec. 22, 2023

(30) Foreign Application Priority Data
Dec. 26, 2022 (CN) 202211678555.2

(51) Int. Cl. G06F 16/957; G06F 16/958

(52) U.S. Cl. CPC G06F 16/957; G06F 16/958

(57) ABSTRACT

The present disclosure relates to an information transmission method, a sharing end, a server and an electronic apparatus. The method includes: obtaining target transmitted information of a target webpage; modifying first description information of the target webpage into target description information according to the target transmitted information, wherein the target description information includes the target transmitted information and the first description information; controlling a target application to read the target transmitted information through a system application program interface API to obtain target information.

### CROSS-REFERENCE TO RELATED APPLICATION

The present application claims priority to Chinese Patent Application No. 202211678555.2, filed on Dec. 26, 2022, which is incorporated herein by reference in its entirety.

### TECHNICAL FIELD

The present disclosure relates to the field of computer technology, in particular to an information transmission method, a sharing end, a server and an electronic apparatus.

### BACKGROUND

The development environment for World Wide Web (Web) applications can be regarded as a Sandbox environment with limited API. As a host, the browser does not expose most of the system's capabilities to the Web applications for their usage. At present, under normal circumstances, the Web applications can't transmit information to other applications in the system. Generally, the information transmission between Web applications and other applications is carried out through a server, which will lead to the problem of larger delay in information transmission.

### SUMMARY

In order to solve the above technical problems or at least partially solve the above technical problems, the present disclosure provides an information transmission method, a sharing end, a server and an electronic apparatus, which can enable other applications to obtain information in the Web directly through the system API, thereby reducing the delay of information transmission.

In order to achieve the above objectives, the embodiments of the present disclosure provide the following technical solutions.

In a first aspect, it provides an information transmission method, including: obtaining target transmitted information of a target webpage; modifying first description information of the target webpage into target description information according to the target transmitted information, wherein the target description information includes the target transmitted information and the first description information; and controlling a target application to read the target transmitted information through a system application program interface API to obtain target information.

In a second aspect, it provides an information transmission method, including: receiving first transmitted information and relevant information of a target webpage sent by a sharing end; storing the first transmitted information and the relevant information of the target webpage in correspondence with each other; receiving second transmitted information sent by the sharing end through a target application; and sending the relevant information of the target webpage stored in correspondence with the first transmitted information to the target application of the sharing end and a shared end in a case that the second transmitted information matches with the first transmitted information.

In a third aspect, it provides an information transmission method, including: receiving an ID of a target webpage sent by a sharing end and storing the ID of the target webpage; receiving the ID of the target webpage and target application data sent by the sharing end through a target application; and sending the target application data to a Web application corresponding to the target webpage according to the ID of the target webpage.

In a fourth aspect, it provides a sharing end, including:
an obtaining module, configured to obtain target transmitted information of a target webpage;
a modifying module, configured to modify first description information of the target webpage into target description information according to the target transmitted information, wherein the target description information includes the target transmitted information and the first description information; and
a reading module, configured to control a target application to read the target transmitted information through a system application program interface API to obtain target information.

In a fifth aspect, it provides a server, including: a receiving module, a sending module and a storage module;
the receiving module is configured to receive first transmitted information and relevant information of a target webpage sent by a sharing end; the storage module is configured to store the first transmitted information and the relevant information of the target webpage in correspondence with each other; the receiving module is further configured to receive second transmitted information sent by the sharing end through a target application; the sending module is configured to send the relevant information of the target webpage stored in correspondence with the first transmitted information to the target application of the sharing end and a shared end in a case that the second transmitted information matches with the first transmitted information;
or,
the receiving module is configured to receive an ID of the target webpage sent by the sharing end; the storage modules configured to store the ID of the target webpage; the receiving module is further configured to receive the ID of the target webpage and target application data sent by the sharing end through the target application; the sending module is configured to send the target application data to a Web application corresponding to the target webpage according to the ID of the target webpage.

In a sixth aspect, it provides an electronic apparatus, including a processor, a memory, and a computer program stored in the memory and executable on the processor, wherein the computer program is configured to realize any of the following information transmission methods in a case that the computer program is executed by the processor:
the information transmission method as described in the first aspect or any of the alternative implementations;
the information transmission method as described in the second aspect or any of the alternative implementations;
the information transmission method as described in the third aspect or any of the alternative implementations.

In a seventh aspect, it provides a computer-readable storage medium, including a computer program stored in the computer-readable storage medium, wherein the computer program is configured to realize any of the following information transmission methods in a case that the computer program is executed by a processor:
the information transmission method as described in the first aspect or any of the alternative implementations;
the information transmission method as described in the second aspect or any of the alternative implementations;
the information transmission method as described in the third aspect or any of the alternative implementations.

In an eighth aspect, it provides a computer program product including a computer program stored in the computer program product, wherein the computer program is configured to realize any of the following information transmission methods in a case that the computer program is executed by a processor:
the information transmission method as described in the first aspect or any of the alternative implementations;
the information transmission method as described in the second aspect or any of the alternative implementations;
the information transmission method as described in the third aspect or any of the alternative implementations.

The information transmission method provided by the embodiment of the present disclosure includes: obtaining target transmitted information of a target webpage; modifying first description information of the target webpage into target description information according to the target transmitted information, wherein the target description information includes the target transmitted information and the first description information; and controlling a target application to read the target transmitted information through a system application program interface API to obtain target information. Through the technical solution above, the target transmitted information of the target webpage can be added to the description information of the target webpage, so that the target description information including the original first description information and the target transmitted information can be obtained, and that the target transmitted information in the above-mentioned target description information can be read by the target application through the system API to obtain the target information; in this way, the target application can directly obtain the information in the Web application without the server, thereby reducing the delay of information transmission.

### BRIEF DESCRIPTION OF THE DRAWINGS

The accompanying drawings, which are incorporated in and constitute a part of the specification, illustrate embodiments consistent with the present disclosure and together with the description, serve to explain the principles of the present disclosure.

In order to more clearly explain the technical solutions in the embodiments of the present disclosure or the prior art, the drawings necessary for description of the embodiments or the prior art will be briefly introduced below. Obviously, for ordinary skilled in the art, other drawings can be obtained according to these drawings without creative labors.

FIG. 1 is a schematic diagram of an implementation scenario of an information transmission method provided by an embodiment of the present disclosure;

FIG. 2 is a first flow chart of an information transmission method provided by an embodiment of the present disclosure;

FIG. 3 is a second flow chart of an information transmission method provided by an embodiment of the present disclosure;

FIG. 4 is a third flow chart of an information transmission method provided by an embodiment of the present disclosure;

FIG. 5 is a schematic structural diagram of a sharing end provided by an embodiment of the present disclosure;

FIG. 6 is a schematic structural diagram of a server provided by an embodiment of the present disclosure; and

FIG. 7 is a schematic diagram of a hardware structure of an electronic apparatus provided by an embodiment of the present disclosure.

### DETAILED DESCRIPTION

In order to understand the above objectives, features and advantages of the present disclosure more clearly, the technical solutions of the present disclosure will be further described below. It should be noted that the embodiments of the present disclosure and the features in the embodiments can be combined with each other in case of conflict.

In the following description, many specific details are set forth in order to fully understand the present disclosure, but the present disclosure may be practiced in other ways different from those described herein. Obviously, the embodiments in the specification are only part of but not all the embodiments of the present disclosure.

At present, the development environment for Web applications can be regarded as a Sandbox environment with limited API, and the browser, as the host, does not expose most of the system's capabilities to the Web applications. Under normal circumstances, the Web applications can't transmit information to other applications in the system. Generally, the information transmission between Web applications and other applications is carried out through the server, which will result in the problem of larger delay in information transmission. In order to solve the above problems, the embodiment of the present disclosure provides an information transmission method, which enables the target application to directly obtain the information in the Web application without the server, thus reducing the delay of information transmission.

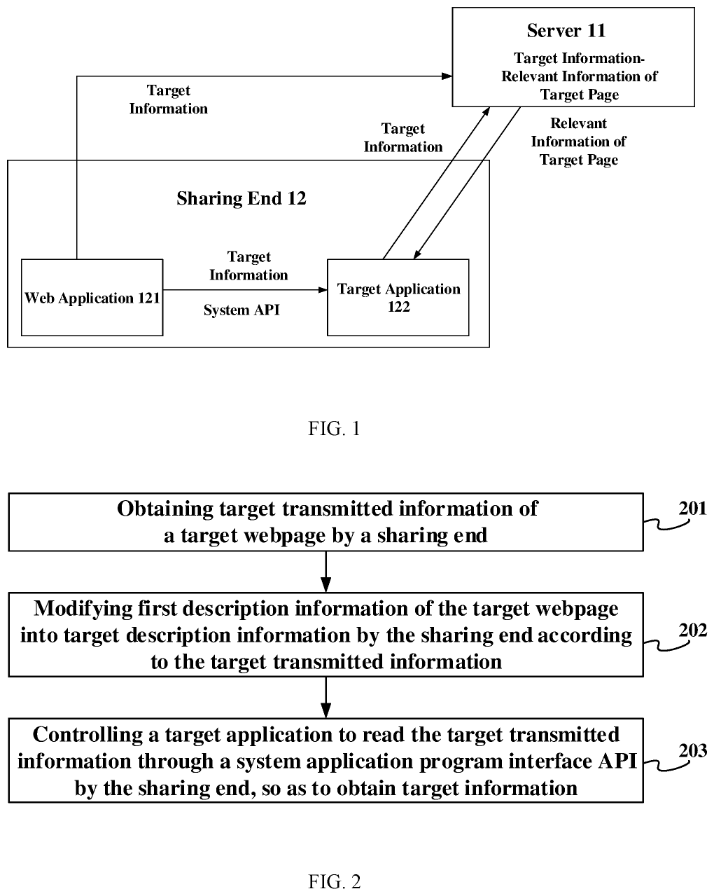

FIG. 1 is a schematic diagram of an implementation scenario of an information transmission method provided by an embodiment of the present disclosure.

As shown in FIG. 1, the implementation scenario provided for the embodiments of the present disclosure includes a server 11, and a sharing end 12 in which a Web application 121 and a target application 122 are running. The sharing end 12 can be a local device.

The above-mentioned Web application 121, when running, can open a webpage in a browser, generate target transmitted information of the webpage, and add the target transmitted information to description information of the webpage. The above-mentioned target application 122 can read the target transmitted information generated in the Web application 121 through a system API; e.g., the target application 122 can read the target transmitted information when it reads the description information of the webpage, thereby obtaining target information. In this scenario, the communication of the target information between the target application 122 and the Web application 121 can be completed without a server.

The target application 121 in the embodiment of the present disclosure can be any application that can invoke the system API, and the target information can be the target transmitted information or the first transmitted information involved in the embodiment of the present disclosure.

Further, the Web application 121 can also send the target information to the server 11, so that the server 11 can store the target information and the relevant information of the webpage in correspondence with each other. The target application 122 can also send the target information to the server 11, so that the server 11 returns the relevant information of the webpage stored in correspondence with the target information to the target application 122. In this scenario, the transmission of the relevant information of the webpage stored in correspondence with the target information between the target application 122 and the Web application 121 can be realized through the server.

The information transmission method provided in the embodiment of the present disclosure can be realized by a local device (sharing end), the present implementation and the local device, or can be realized by an interaction between the local device and the server. For example, the local device may include a personal computer, a tablet computer, a mobile phone, a notebook computer, a palmtop computer, a vehicle-mounted terminal, a wearable device, etc., which is not specifically limited in the embodiment of the present disclosure.

FIG. 2 is a first flow chart of an information transmission method provided by an embodiment of the present disclosure.

As shown in FIG. 2, this information transmission method includes but is not limited to the following steps.

S201, obtaining target transmitted information of a target webpage.

The target webpage can be any webpage.

In some embodiments, the local device can obtain the target transmitted information of the target webpage in response to opening the target webpage in the browser.

In some embodiments, the local device can also obtain the target transmitted information of the target webpage in response to switching from other webpages to the target webpage in the browser.

The target transmitted information includes an ID of the target webpage and/or current browsing position information of the target webpage.

The target transmitted information may be a zero-width character string composed of zero-width characters, and the target transmitted information may also be a character string composed of other characters.

In some embodiments, obtaining the target transmitted information of the target webpage may include, but is not limited to, obtaining first transmitted information of the target webpage, and then converting the first transmitted information into the target transmitted information composed of zero-width characters. The first transmitted information refers to the transmitted information that has not undergone format conversion or other processing.

The target transmitted information and the first transmitted information correspond to the same substantive information, both of which may include the ID of the target webpage and/or the current browsing position information of the target webpage, but the character formats of the target transmitted information and the first transmitted information are different.

For example, description is given with reference to the case where the substantive information corresponding to the target transmitted information and the first transmitted information is the ID of the target webpage. When opening the target webpage in the browser at first, it can generate a unique ID of the target webpage in 32-bit hexatrigesimal format, that is, the above-mentioned first transmitted information, and then convert the 32-bit hexatrigesimal number into the target transmitted information composed of zero-width characters.

Assuming that the first transmitted information is a 32-bit hexatrigesimal number representing the unique ID of the target webpage, it may specifically be, “81c713b7-4132-4323-977e-99429ca82d62”, which can also be written as “81c713b741324323977e99429ca82d62”. In a case that ten zero-width characters are used, by way of example, it can firstly convert the 32-bit hexatrigesimal number “81c713b741324323977e99429ca82d62” into a decimal number, and the decimal number obtained after conversion is “14141049284489415180575729099041953590882401787690”. Further, the ten zero-width characters shown in Table 1 as below are used to represent 0 to 9, respectively, so as to obtain the target transmitted information.

TABLE 1

| Zero-width | Decimal | |
|---|---|---|
| Character | Number | Conventional usages of zero-width characters |
| U + 200B | 0 | ZERO-WIDTH SPACE, used for newline separation of longer words. |
| U + 200C | 1 | ZERO-WIDTH NON-JOINER, used in Arabic, German, Indian |
| | | languages and other languages to avoid hyphenation effect between |
| | | characters in which hyphenation may occur. |
| U + 200D | 2 | ZERO-WIDTH JOINER, used in Arabic, German, Indian languages |
| | | and other languages to enable hyphenation effect to be occurred |
| | | between characters that wouldn't otherwise hyphenate. |
| U + 202C | 3 | POP DIRECTIONAL FORMATTING, used for specifying writing |
| | | order of characters in typesetting. |
| U + 2060 | 4 | WORD JOINER, used for avoiding a line break at its potion. |
| U + 2061 | 5 | FUNCTION APPLICATION character, used for distinguishing serial |
| | | characters representing function application from serial characters |
| | | representing multiplication. |
| U + 2062 | 6 | INVISIBLE TIMES, used for representing a multiplication sign. |
| U + 2063 | 7 | INVISIBLE SEPARATOR, used for representing a separator. |
| U + 2064 | 8 | INVISIBLE PLUS, used for indicating a plus sign. |
| U + FEFF | 9 | ZERO WIDTH NO-BREAK SPACE, used for avoiding line breaks |
| | | at specific positions. |

According to Table 1, the decimal number “81c713b741324323977e99429ca82d62” can be converted into “U+200C U+2060 U+200C U+2060 U+200C U+200B U+2060 U+FEFF U+200D U+2064 U+2060 U+2060 U+2064 U+FEFF U+2060 U+200C U+2061 U+200C U+2064 U+200B U+2061 U+2063 U+2061 U+2063 U+200D U+FEFF U+200B U+FEFF U+FEFF U+200B U+2060 U+200C U+FEFF U+2061 U+202C U+2061 U+FEFF U+200B U+2064 U+2064 U+200D U+2060 U+200B U+200C U+2063 U+2064 U+2063 U+2062 U+FEFF U+200B”, that is, the target transmitted information.

It should be noted that the above-listed conventional usages of zero-width characters are not applied in the embodiments of the present disclosure for information transmission. Instead, in the embodiments of the present disclosure, the information transmission is performed by converting the first transmitted information as generated into the form of zero-width characters.

In the above embodiment, the first transmitted information as generated is converted into the form of zero-width characters for information transmission, so that the information to be transmitted will not be displayed in the transmission process. Therefore, the information transmission process will not be perceived by the user, and the normal display of the target webpage will not be affected, which not only can realize the information transmission without the server and reduce the delay in information transmission, but also can improve the user experience.

In the embodiment of the present disclosure, the conventional usage of the above 10 zero-width characters will not affect the display position of the first description information in the original webpage, so that the user will not perceive the information transmission process and will not affect the normal display of the first description information in the target webpage, and the user experience can be improved.

S202, modifying first description information of the target webpage into target description information by a sharing end according to the target transmitted information.

The target description information includes target transmitted information and first description information. It is understood that the target description information is obtained by adding the target transmitted information to the first description information.

In the embodiment of the present disclosure, the first description information includes title information of the target webpage.

In some embodiments, the first description information may also refer to other information normally displayed in the target webpage. For example, introduction information of the target webpage, page header information or page footer information of a document in the target webpage, etc.

In the embodiment of the present disclosure, when the opening of the target webpage is detected, the first description information of the target webpage is modified into the target description information according to the target transmitted information.

In the process of creating the target webpage, an operation of opening the target webpage will be executed, and the first description information of the target webpage will be modified into the target description information according to the target transmitted information when the opening of the target webpage is detected. Alternatively, the first description information of the target page can also be modified into the target description information according to the target transmitted information when the target page is opened later after the target page is created.

For example, assuming that the first description information is a title of a document in the target webpage and is denoted as “A”, and the target transmitted information is a 50-bit zero-width character string “U+200C U+2060 U+200C U+2060 U+200C U+200B U+2060 U+FEFF U+200D U+2064 U+2060 U+2060 U+2064 U+FEFF U+2060 U+200C U+2061 U+200C U+2064 U+200B U+2061 U+2063 U+2061 U+2063 U+200D U+FEFF U+200B U+FEFF U+FEFF U+200B U+2060 U+200C U+FEFF U+2061 U+202C U+2061 U+FEFF U+200B U+2064 U+2064 U+200D U+2060 U+200B U+200C U+2063 U+2064 U+2063 U+2062 U+FEFF U+200B”, then the title of the target webpage can be modified as “50-bit zero-width character string A”, that is, “U+200C U+2060 U+200C U+2060 U+200C U+200B U+2060 U+FEFF U+200D U+2064 U+2060 U+2060 U+2064 U+FEFF U+2060 U+200C U+2061 U+200C U+2064 U+200B U+2061 U+2063 U+2061 U+2063 U+200D U+FEFF U+200B U+FEFF U+FEFF U+200B U+2060 U+200C U+FEFF U+2061 U+202C U+2061 U+FEFF U+200B U+2064 U+2064 U+200D U+2060 U+200B U+200C U+2063 U+2064 U+2063 U+2062 U+FEFF U+200B A”.

It should be noted that the above-mentioned way of using 10 zero-width characters to represent 0 to 9, respectively, is only an exemplary description, and in practice, more zero-width characters or fewer zero-width characters can be used to obtain the target transmitted information composed of zero-width character string, which is not limited in the embodiments of the present disclosure.

S203, controlling a target application to read the target transmitted information through a system application program interface API, so as to obtain target information.

In some embodiments, after the target transmitted information is obtained through the system application program interface API and transmitted to the target application, the target transmitted information can be converted into first transmitted information. According to the information transmission method provided by the embodiment of the present disclosure, the target transmitted information of the target webpage can be added to the description information of the target webpage, so that target description information including the original first description information and the target transmitted information can be obtained, which enables the target application to read the target transmitted information in the target description information through the system API; in this way, the target application can directly obtain the information in the Web application without the server, thereby reducing the delay in information transmission.

In some embodiments, after the target application reads the target transmitted information through the system application program interface API to obtain the target information, the number of characters in the target information can be detected. When the number of characters in the target information is greater than or equal to a preset number, the target application converts the target information into second transmitted information.

The preset number is determined based on at least one of: a carry counting system of the first transmitted information, the number of characters of the first transmitted information, and the number of types of the zero-width characters used for converting the first transmitted information. The carry counting system and the number of characters of the above-mentioned transmitted information, as well as the number of types of the zero-width characters used for converting the first transmitted information all can be preset, fixed values.

For example, assuming that the first transmitted information is a 32-bit Hexatrigesimal number and written as “81c713b741324323977e99429ca82d62”, if the number of types of the zero-width characters used for converting the first transmitted information is 10 in the above-mentioned Table 1, it can be known that “81c713b741324323977e99429ca82d62” will become a 50-bit zero-width character string after conversion into zero-width character string, that is to say, the target information as obtained should be 50 bits, and the above-mentioned preset number can be set as 50 in this case.

In the above embodiment, in a case that the number of characters in the target information is greater than or equal to the preset number, the target information is converted into the second transmitted information. When the number of characters in the target information is greater than or equal to the preset number, it indicates that the target information may contain complete information to be transmitted. Before the target information is converted into the second transmitted information, the correctness is verified once based on the number of characters, so as to ensure that the number of characters can reach the number required for correct transmission of the information. In this way, it can avoid converting the received target information when the number of characters is too small, which may result in that the correct second transmitted information cannot be obtained.

In some embodiments, the controlling the target application to read the target transmitted information through the system application program interface API to obtain the target information may include, but is not limited to, controlling the target application to read the target transmitted information through the system API to obtain the target information in a case that an update of the description information of the target webpage is detected.

Because the browser sometimes may modify the title of the webpage, the target application needs to verify whether the description information has changed at a certain time interval. Every time a change of the description information is detected, it reads the target description information of the webpage to obtain the target transmitted information, and transmits the target transmitted information to the target application.

The target application can regularly verify whether the description information of the webpage has changed through the system API, and re-obtain the target transmitted information when a change is detected, so as to obtain the latest transmitted information and description information in time.

In some embodiments, after obtaining the target transmitted information of the target webpage, the sharing end can also send the first transmitted information and relevant information of the target webpage to the server, so that the server can store the first transmitted information and the relevant information of the target webpage in correspondence with each other. After the sharing end converts the target transmitted information into the second transmitted information, the server can return the relevant information of the target webpage stored in correspondence with the first transmitted information to the target application under the condition that the second transmitted information matches with the first transmitted information; and the target application receives the relevant information of the target webpage sent by the server.

In some embodiments, the target transmitted information includes an ID of the target webpage and/or an ID of a target content corresponding to the target webpage, and the relevant information of the target webpage includes: an URL address of the target webpage and/or a current browsing position of the target webpage.

In some embodiments, the target transmitted information includes the current browsing position information of the target webpage, and the relevant information of the target webpage includes the URL address of the target webpage.

In some embodiments, the target transmitted information includes the ID of the target webpage and the current browsing position information of the target webpage; and the relevant information of the target webpage includes the URL address of the target webpage.

In the above embodiment, the server can help the target application to obtain the relevant information (the URL address and the current browsing position) of the webpage in the Web application, so that the native application can obtain more information of the target webpage in the Web application, thereby realizing the transmission of more information.

In some embodiments, the first transmitted information includes the ID of the target content corresponding to the target webpage. After the sharing end converts the target information into the second transmitted information through the target application, the sharing end can send the ID of the target content corresponding to the target webpage to the server through the target application. After the corresponding server receives the ID of the target content, the server verifies whether a service type of the target content is a shared content type according to the ID of the target content, and returns the relevant information of the target webpage stored in correspondence with the first transmitted information to the target application in a case that the service type is the shared content type and the second transmitted information matches with the first transmitted information.

The server can store corresponding relationships between IDs of various contents and different service types. The server stores the first transmitted information and the relevant information of the target webpage in correspondence with each other.

After the server obtains the ID of the target content, it can determine whether the corresponding service type is a shared content type so as to verify whether the service type is a shared content type. If it is determined that the service type is a shared content type, it means that the relevant information of the target webpage is allowed to be shared. At this time, if it is further verified that the second transmitted information matches with the first transmitted information, the relevant information of the target webpage stored in correspondence with the first transmitted information can be sent to the target application of the sharing end and the shared end, thus realizing the sharing of the relevant information of the target webpage with the target application of both the sharing end and the shared end.

Through the above embodiment, before the server shares the relevant information of the target webpage with the target application, it first verifies whether the target webpage is of a service type that is allowed to be shared based on the ID of the target content of the target webpage sent by the sharing end, and further verifies whether the second transmitted information obtained by the target application matches with the first transmitted information transmitted by the target webpage, so as to determine that the relevant information of the target webpage is allowed to be shared with the target application. In this way, the relevant information of the target webpage is sent to the target application after such verifications, thus ensuring the security of transmission of the relevant information of the target webpage.

In some embodiments, after the sharing end sends the first description information and/or the shared user ID of the target webpage to the server, and after the server receives the first description information and/or the shared user ID of the target webpage, the server can store the first description information and the first transmitted information in correspondence with each other, and/or store the shared user ID of the target webpage and the first transmitted information in correspondence with each other.

After the sharing end modifies the first description information of the target webpage into the target description information according to the target transmitted information, the sharing end can control the target application to read the first description information through the system API to obtain the second description information; after the sharing end converts the target information into the second transmitted information through the target application, it can also send the second description information and/or the current shared user ID of the target webpage to the server through the target application, so that the server can verify the second description information according to the first description information as stored, and/or verify the current shared user ID as received according to the shared user ID of the target webpage as stored. When the second transmitted information matches with the first transmitted information, the relevant information of the target webpage stored in correspondence with the first transmitted information is sent to the target application of the sharing end and the shared end; and when the verification is passed and the second transmitted information matches with the first transmitted information, the relevant information of the target webpage stored in correspondence with the first transmitted information is sent to the target application of the sharing end and the shared end.

When the verification on the second description information according to the first description information as stored is passed, it indicates that the currently shared target webpage is the webpage that is actually expected to be shared. When the verification on the current shared user ID as received according to the shared user ID of the target webpage as stored is passed, it indicates that the shared user ID as stored is consistent with the current shared user ID, and the user who currently shares the target webpage is a shared user. Through the above-mentioned verification method, the shared webpage and the user who is sharing the webpage are verified safely before the relevant information of the target webpage is sent to the target application of the sharing end and the shared end, thus further ensuring the security of webpage sharing.

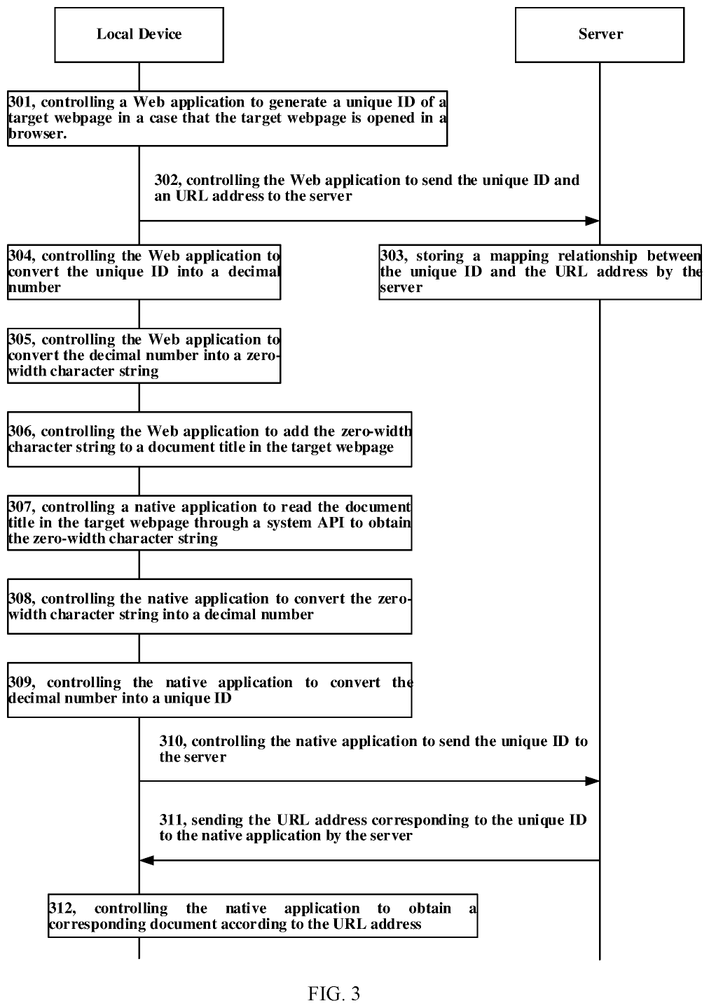

FIG. 3 is a second flow chart of an information transmission method provided by an embodiment of the present disclosure.

As shown in FIG. 3, the information transmission method includes, but is not limited to, the following steps:

S301, controlling a Web application to generate a unique ID of a target webpage in a case that the target webpage is opened in a browser.

The unique ID can be a 32-bit hexatrigesimal number, which is the first transmitted information involved in the embodiment of the present disclosure.

S302, controlling the Web application to send the unique ID and an URL address to a server.

S303, storing a mapping relationship between the unique ID and the URL address by the server.

S304, controlling the Web application to convert the unique ID into a decimal number.

S305, controlling the Web application to convert the decimal number into a zero-width character string.

S306, controlling the Web application to add the zero-width character string to a document title in the target webpage.

In the embodiment of the present disclosure, description is given with reference to the case where the webpage has an opened document by way of example. In practice, the target webpage can also be other pages, and the embodiment of the present disclosure is not limited here.

S307, controlling a native application (Native APP) to read the document title in the target webpage through a system API to obtain the zero-width character string.

The native application can be one type of application of the target applications. The above-mentioned zero-width character string can be the target transmitted information involved in the embodiment of the present disclosure.

S308, controlling the native application to convert the zero-width character string into a decimal number.

S309, controlling the native application to convert the decimal number into a unique ID.

In the above steps of this embodiment, the native application directly reads the unique ID of the target webpage in the Web application through the system API, thus reducing the delay when the native application obtains the information in the Web application.

S310, controlling the native application to send the unique ID to the server.

S311, sending an URL address corresponding to the unique ID to the native application by the server.

S312, controlling the native application to obtain a corresponding document according to the URL address.

In the above embodiment, by storing a corresponding relationship between the unique ID and the URL address in the server, the native application can obtain the corresponding, stored, URL address from the server after reading the unique ID through the system API, and obtain the corresponding document through the URL address. In this embodiment, the server can also help the native application to obtain the URL address of the webpage in the Web application, so that the native application can obtain the document displayed in the target webpage, and the transmission of more information can be realized.

In some embodiments, the target transmitted information is the ID of the target webpage represented by a zero-width character string, and after the sharing end obtains the target transmitted information of the target webpage, it can also send the ID of the target webpage to the server, so that the server can store the ID of the target webpage. After the target transmitted information is converted into the second transmitted information, it can also send the ID of the target webpage and the target application data to the server through the target application, so that the server can send the target application data to the Web application corresponding to the target webpage according to the ID of the target webpage.

The target application data can be related data of a certain function in the target application, and the function can be a function associated with the target webpage. After the Web application receives the data of the certain function, the Web application can determine whether it is necessary to control an update or control a modification of the display of the target webpage based on the function.

In the above embodiment, the server can help the target application to send the target data to the Web application, so that more information can be transmitted.

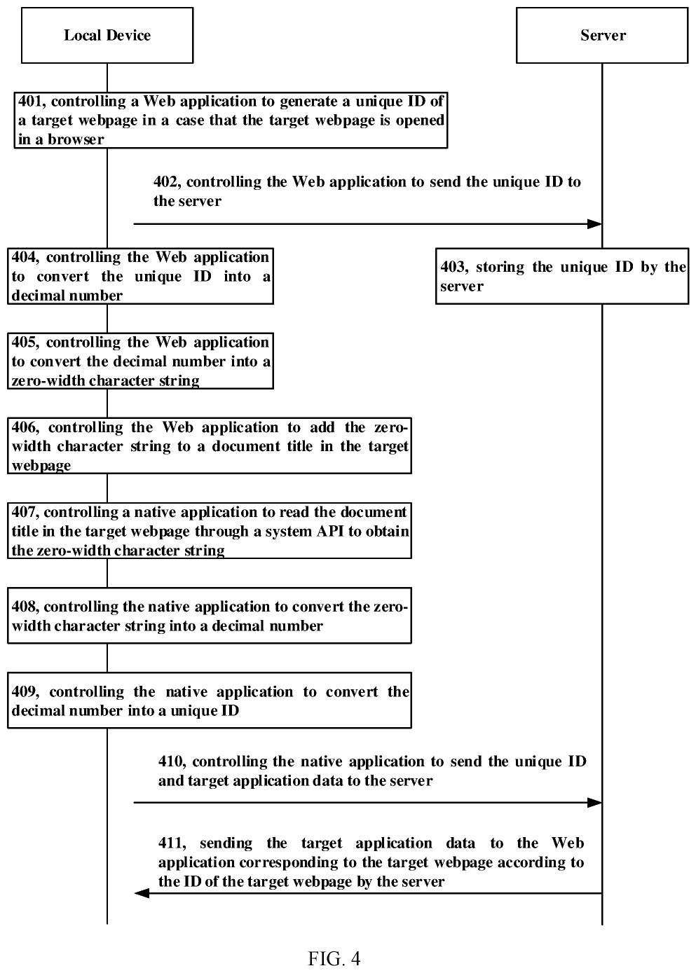

FIG. 4 is a third flow chart of an information transmission method provided by an embodiment of the present disclosure.

As shown in FIG. 4, the information transmission method includes, but is not limited to, the following steps.

S401, controlling a Web application to generate a unique ID of a target webpage in a case that the target webpage is opened in a browser.

The unique ID may be the first transmitted information involved in the embodiment of the present disclosure.

S402, controlling the Web application to send the unique ID to a server.

S403, storing the unique ID by the server.

S404, controlling the Web application to convert the unique ID into a decimal number.

S405, controlling the Web application to convert the decimal number into a zero-width character string.

S406, controlling the Web application to add the zero-width character string to a document title in the target webpage.

In the embodiment of the present disclosure, description is given with reference to the case where the webpage has an opened document by way of example. In practice, the target webpage can also be other pages, and the embodiment of the present disclosure is not limited here.

S407, controlling a native application to read the document title in the target webpage through a system API to obtain the zero-width character string.

The native application can be one type of application of the target applications. The above-mentioned zero-width character string can be the target transmitted information involved in the embodiment of the present disclosure.

S408, controlling the native application to convert the zero-width character string into a decimal number.

S409, controlling the native application to convert the decimal number into a unique ID.

In the above steps of this embodiment, the native application directly reads the unique ID of the target webpage in the Web application through the system API, thus reducing the delay when the native application obtains the information in the Web application.

S410, controlling the native application to send the unique ID and target application data to the server.

S411, sending the target application data to the Web application corresponding to the target webpage according to the ID of the target webpage by the server.

In the above embodiment, the server can help the native application to send the target application data to the Web application, so that more information can be transmitted.

The target application data can be related data of a certain function in the native application. This function can be a function associated with the target webpage. After the Web application receives the data of this certain function, the Web application can determine whether it is necessary to control an update or control a modification of the display of the target webpage based on this function.

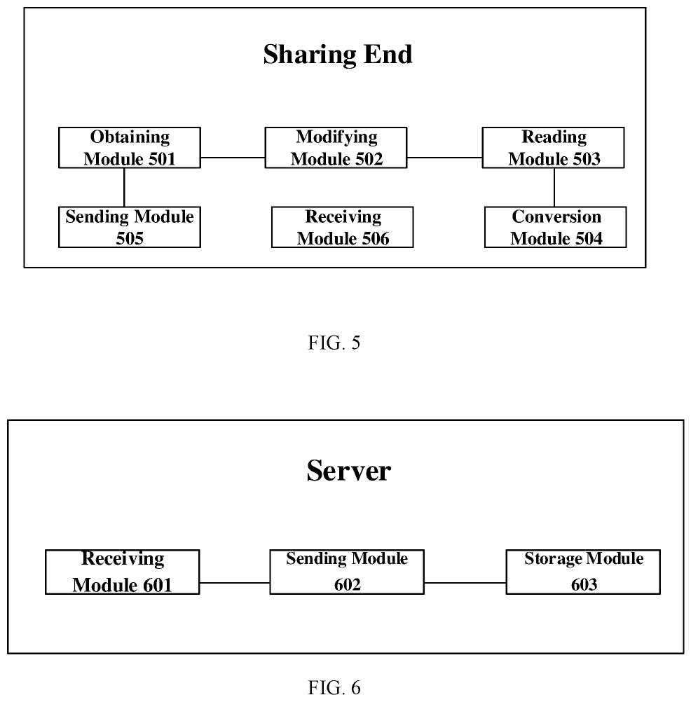

FIG. 5 is a schematic structural diagram of a sharing end provided by an embodiment of the present disclosure.

As shown in FIG. 5, the sharing end includes:
an obtaining module 501, configured to obtain target transmitted information of a target webpage;
a modifying module 502, configured to modify first description information of the target webpage into target description information according to the target transmitted information, wherein the target description information includes the target transmitted information and the first description information; and
a reading module 503, configured to control a target application to read the target transmitted information through a system application program interface API to obtain target information.

In some embodiments, the target transmitted information is a zero-width character string; the obtaining module 501 is specifically configured to obtain first transmitted information of the target webpage, and covert the first transmitted information into the zero-width character string.

In some embodiments, the reading module 503 is specifically configured to:
control the target application to read the zero-width character string through the system API to obtain the target information;
the sharing end also includes a conversion module 504, which is configured to convert the target information into second transmitted information through the target application.

In some embodiments, the conversion module 504 is specifically configured to convert the target information into the second transmitted information through the target application in a case that the number of characters in the target information is greater than or equal to a preset number; wherein the preset number is determined based on at least one of the following: the carry counting system of the first transmitted information, the number of characters of the first transmitted information, and the number of types of the zero-width characters used for converting the first transmitted information.

In some embodiments, the sharing end also includes a sending module 505, which is configured to send the first transmitted information and relevant information of the target webpage to the server after the obtaining module 501 obtains the first transmitted information of the target webpage, so that the server can store the first transmitted information and relevant information of the target webpage in correspondence with each other;
the sending module 505 is further configured to send the second transmitted information to the server through the target application after the conversion module 504 converts the target information into the second transmitted information through the target application, so that the server can return the relevant information of the target webpage stored in correspondence with the first transmitted information to the target application in a case that the second transmitted information matches with the first transmitted information; the sharing end also includes a receiving module 506, which is configured to receive the relevant information of the target webpage sent by the server.

In some embodiments, the first transmitted information includes an ID of the target webpage and/or an ID of a target content corresponding to the target webpage; and the relevant information of the target webpage includes: an URL address of the target webpage and/or a current browsing position of the target webpage.

In some embodiments, the first transmitted information includes current browsing position information of the target webpage; and the relevant information of the target webpage includes the URL address of the target webpage.

In some embodiments, the first transmitted information includes the ID of the target content corresponding to the target webpage, and the sending module 505 is further configured to send the ID of the target content corresponding to the target webpage to the server through the target application after the conversion module 504 converts the target information into the second transmitted information through the target application, so that the server can verify whether a service type of the target content is a shared content type according to the ID of the target content, and can return the relevant information of the target webpage stored in correspondence with the first transmitted information to the target application in a case that the service type is the shared content type and the second transmitted information matches with the first transmitted information.

In some embodiments, after the obtaining module 501 obtains the first transmitted information of the target webpage, the sending module 505 is further configured to: send first description information and/or shared user ID of the target webpage to the server, so that the server can store the first description information and the first transmitted information in correspondence with each other, and/or, store the shared user ID of the target webpage and the first transmitted information in correspondence with each other;
after the modifying module 502 modifies the first description information of the target webpage into target description information according to the target transmitted information, the reading module 503 is further configured to control the target application to read the first description information through the system API to obtain second description information; after the conversion module 504 converts the target information into second transmitted information through the target application, the sending module 505 is further configured to send the second description information and/or a current shared user ID of the target webpage to the server through the target application, so that the server can verify the second description information according to the first description information as stored and/or verify the current shared user ID as received according to the shared user ID of the target webpage as stored.

In some embodiments, the first transmitted information is an ID of the target webpage. After the obtaining module 501 obtains the first transmitted information of the target webpage, the sending module 505 is further configured to send the ID of the target webpage to the server, so that the server can store the ID of the target webpage; after the conversion module 504 controls the target application to convert the target information into the second transmitted information, the sending module 505 is further configured to send the ID of the target webpage and target application data to the server through the target application, so that the server can send the target application data to a Web application corresponding to the target webpage according to the ID of the target webpage.

In some embodiments, the reading module 503 is specifically configured to control the target application to read the target transmitted information through a system API to obtain the target information in a case that an update of description information of the target webpage is detected.

In some embodiments, the modifying module 502 is specifically configured to modify the first description information of the target webpage into target description information according to the target transmitted information in a case that an opening of the target webpage is detected.

In some embodiments, the first description information includes title information of the target webpage.

FIG. 6 is a schematic structural diagram of a server provided by an embodiment of the present disclosure. As shown in FIG. 6, the server includes a receiving module 601, a sending module 602 and a storage module 603;
the receiving module 601 is configured to receive first transmitted information and relevant information of a target webpage sent by a sharing end; the storage module 603 is configured to store the first transmitted information and the relevant information of the target webpage in correspondence with each other; the receiving module 601 is further configured to receive second transmitted information sent by the sharing end through a target application; the sending module 602 is configured to send the relevant information of the target webpage stored in correspondence with the first transmitted information to a target application of the sharing end and an shared end in a case that the second transmitted information matches with the first transmitted information;
alternatively;
the receiving module 601 is configured to receive an ID of a target webpage sent by a sharing end; the storage module 603 is configured to store the ID of the target webpage; the receiving module 601 is also configured to receive the ID and target data of the target webpage sent by the sharing end through a target application; the sending module 602 is configured to send the target data to a Web application corresponding to the target webpage according to the ID of the target webpage.

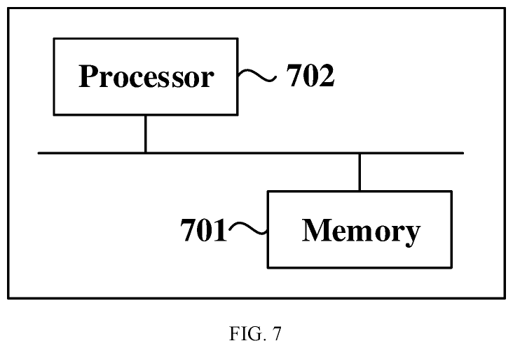

FIG. 7 is a schematic diagram of a hardware structure of an electronic apparatus provided by an embodiment of the present disclosure. As shown in FIG. 7, the electronic apparatus includes a processor 701, a memory 702, and a computer program stored in the memory 702 and executable on the processor 701. When the computer program is executed by the processor 701, each process of the information transmission method executed by the sharing end or the server in the above method embodiments is realized, and the same technical effects can be achieved. Thus, in order to avoid repetition, the details will be omitted here.

An embodiment of the present disclosure provides a computer-readable storage medium, which is characterized in that a computer program is stored on the computer-readable storage medium, and when the computer program is executed by a processor, each process of the information transmission method in the above-mentioned method embodiment can be realized, and the same technical effects can be achieved. Thus, in order to avoid repetition, the details will be omitted here.

The computer-readable storage medium can be read-only memory (ROM), random access memory (RAM), magnetic disk or optical disk, etc.

An embodiment of the present disclosure provides a computer program product, which stores a computer program. When the computer program is executed by a processor, each process of the information transmission method in the above method embodiment can be realized, and the same technical effects can be achieved. Thus, in order to avoid repetition, the details will be omitted here.

It should be understood by those skilled in the art that embodiments of the present disclosure can be provided as a method, a system, or a computer program product. Therefore, the present disclosure can take the form of an entirely hardware embodiment, an entirely software embodiment, or an embodiment combining software and hardware aspects. Moreover, the present disclosure may take the form of a computer program product embodied on one or more computer usable storage medium having computer usable program codes embodied therein.

In the present disclosure, the processor can be a central processing unit (CPU), and can also be other general processors, a digital signal processor (DSP), an application specific integrated circuit (ASIC), a field-programmable gate array (FPGA) or other programmable logic devices, a discrete gate or a transistor logic device, a discrete hardware component or the like. The general processor can be a microprocessor, or the processor can also be any conventional processor or the like.

The memory may include the form of a non-permanent memory, a random-access memory (RAM) and/or a non-volatile memory in a computer-readable medium, such as a read-only memory (ROM) or a flash memory. The memory is an example of the computer-readable medium.

In the present disclosure, computer-readable medium includes a permanent or non-permanent, removable or non-removable storage medium. The storage medium can store information by means of any method or technology, and the information can be computer-readable instructions, data structures, program modules or other data. Examples of the storage medium for computers include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette, magnetic disk storage or other magnetic storage devices or any other non-transmission medium, which can be used for storing information accessible by a computing apparatus. According to the definition in the present disclosure, the computer-readable medium does not include transitory media, such as modulated data signals and carrier waves.

It should be noted that in the present disclosure, relational terms such as “first” and “second” are only used to distinguish one entity or operation from another entity or operation, and do not necessarily require or imply that there is any such actual relationship or order between these entities or operations. Moreover, the terms “comprising”, “including” or any other variation thereof are intended to cover non-exclusive inclusion, so that a process, method, article or equipment including a series of elements includes not only those elements, but also other elements not explicitly listed or elements inherent to such process, method, article or equipment. Without more restrictions, the element defined by the phrase “including one” does not exclude that there are other identical elements in the process, method, article or equipment including the element.

The above are only specific embodiments of the present disclosure, so that those skilled in the art can understand or realize the present disclosure. Many modifications to these embodiments will be obvious to those skilled in the art, and the general principles defined herein can be implemented in other embodiments without departing from the spirit or scope of the present disclosure. Therefore, the present disclosure will not be limited to these embodiments herein, but is to be in accordance with the widest scope consistent with the principles and novel features disclosed herein.

What is claimed is:

1. An information transmission method, comprising:
obtaining target transmitted information of a target webpage;
modifying first description information of the target webpage into target description information according to the target transmitted information, wherein the target description information comprises the target transmitted information and the first description information; and
controlling a target application to read the target transmitted information through a system application program interface API to obtain target information.

2. The method according to claim 1, wherein the target transmitted information is a zero-width character string, and the obtaining the target transmitted information of the target webpage comprises:
obtaining first transmitted information of the target webpage; and
converting the first transmitted information into the zero-width character string.

3. The method according to claim 2, wherein the controlling the target application to read the target transmitted information through the system API to obtain the target information comprises:
controlling the target application to read the zero-width character string through the system API to obtain the target information; and
after the controlling the target application to read the target transmitted information through the system API to obtain the target information, the method further comprises:
converting the target information into second transmitted information through the target application.

4. The method according to claim 3, wherein the converting the target information into the second transmitted information through the target application comprises:
converting the target information into the second transmitted information through the target application in a case that a number of characters in the target information is greater than or equal to a preset number;
wherein the preset number is determined based on at least one of: a carry counting system of the first transmitted information, a number of characters in the first transmitted information, and a number of zero-width character types used for converting the first transmitted information.

5. The method according to claim 3, wherein after the obtaining the first transmitted information of the target webpage, further comprising:
sending the first transmitted information and relevant information of the target webpage to a server, so that the server stores the first transmitted information and the relevant information of the target webpage in correspondence with each other;
after the converting the target information into the second transmitted information through the target application, the method further comprises:
sending the second transmitted information to the server through the target application, so that the server returns the relevant information of the target webpage stored in correspondence with the first transmitted information to the target application in a case that the second transmitted information matches with the first transmitted information; and
receiving the relevant information of the target webpage sent by the server.

6. The method according to claim 5, wherein,
the first transmitted information comprises an ID of the target webpage and/or an ID of a target content corresponding to the target webpage; and the relevant information of the target webpage comprises an URL address of the target webpage and/or a current browsing position of the target webpage;
or,
the first transmitted information comprises current browsing position information of the target webpage; and the relevant information of the target webpage comprises the URL address of the target webpage.

7. The method according to claim 6, wherein the first transmitted information comprises the ID of the target content corresponding to the target webpage; and after the converting the target information into the second transmitted information through the target application, the method further comprises:
sending the ID of the target content corresponding to the target webpage to the server through the target application, so that the server verifies whether a service type of the target content is a shared content type according to the ID of the target content, and returns the relevant information of the target webpage stored in correspondence with the first transmitted information to the target application in a case that the service type is the shared content type and the second transmitted information matches with the first transmitted information.

8. The method according to claim 6, wherein after the obtaining the first transmitted information of the target webpage, further comprising:
sending the first description information and/or a shared user ID of the target webpage to the server, so that the server stores the first description information and the first transmitted information in correspondence with each other, and/or stores the shared user ID of the target webpage and the first transmitted information in correspondence with each other;
after the modifying the first description information of the target webpage into the target description information according to the target transmitted information, the method further comprises:
controlling the target application to read the first description information through the system API to obtain second description information;
after the converting the target information into the second transmitted information through the target application, the method further comprises:
sending the second description information and/or a current shared user ID of the target webpage to the server through the target application, so that the server verifies the second description information according to the first description information as stored, and/or verifies the current shared user ID as received according to the shared user ID of the target webpage as stored.

9. The method according to claim 6, wherein the first transmitted information is the ID of the target webpage, and after the obtaining the first transmitted information of the target webpage, the method further comprises:
sending the ID of the target webpage to the server, so that the server stores the ID of the target webpage; and
after the controlling the target application to convert the target information into the second transmitted information, the method further comprises:
sending the ID of the target webpage and target application data to the server through the target application, so that the server sends the target application data to a Web application corresponding to the target webpage according to the ID of the target webpage.

10. The method according to claim 1, wherein the controlling the target application to read the target transmitted information through the system application program interface API to obtain the target information comprises:
controlling the target application to read the target transmitted information through the system API to obtain the target information in a case that an update of description information of the target webpage is detected.

11. The method according to claim 1, wherein the modifying the first description information of the target webpage into the target description information according to the target transmitted information comprises:
modifying the first description information of the target webpage into the target description information according to the target transmitted information in a case that an opening of the target webpage is detected.

12. The method according to claim 1, wherein the first description information comprises title information of the target webpage.

13. An information transmission method, comprising:
receiving first transmitted information and relevant information of a target webpage sent by a sharing end;
storing the first transmitted information and the relevant information of the target webpage in correspondence with each other;
receiving second transmitted information sent by the sharing end through a target application; and
sending the relevant information of the target webpage stored in correspondence with the first transmitted information to the target application of the sharing end and a shared end in a case that the second transmitted information matches with the first transmitted information.

14. The method according to claim 13, wherein
the first transmitted information comprises an ID of the target webpage and/or an ID of a target content corresponding to the target webpage; and the relevant information of the target webpage comprises an URL address of the target webpage and/or a current browsing position of the target webpage;
or,
the first transmitted information comprises current browsing position information of the target webpage, and the relevant information of the target webpage comprises the URL address of the target webpage.

15. The method according to claim 14, wherein the first transmitted information comprises the ID of the target content corresponding to the target webpage, and after the storing the first transmitted information and the relevant information of the target webpage in correspondence with each other, the method further comprises:
receiving the ID of the target content sent by the target application of the sharing end; and
determining a service type corresponding to the ID of the target content;
the sending the relevant information of the target webpage stored in correspondence with the first transmitted information to the target application of the sharing end and the shared end in the case that the second transmitted information matches with the first transmitted information comprises:
sending the relevant information of the target webpage stored in correspondence with the first transmitted information to the target application of the sharing end and the shared end in a case that the service type is a shared content type, and the second transmitted information matches with the first transmitted information.

16. The method according to claim 14, wherein after the storing the first transmitted information and the relevant information of the target webpage in correspondence with each other, the method further comprises:
receiving first description information of the target webpage and/or a shared user ID of the target webpage sent by the sharing end; and
storing the first description information and the first transmitted information in correspondence with each other, and/or, storing the shared user ID of the target webpage and the first transmitted information in correspondence with each other;
the method further comprises:
receiving second description information and/or a current shared user ID of the target webpage sent by the sharing end through the target application;
performing a verification to the second description information according to the first description information as stored, and/or verifying the current shared user ID as received according to the shared user ID of the target webpage as stored;
the sending the relevant information of the target webpage stored in correspondence with the first transmitted information to the target application of the sharing end and the shared end in the case that the second transmitted information matches with the first transmitted information comprises:
sending the relevant information of the target webpage stored in correspondence with the first transmitted information to the target application of the sharing end and the shared end in a case that the verification is passed and the second transmitted information matches with the first transmitted information.

17. An information transmission method, comprising:
receiving an ID of a target webpage sent by a sharing end and storing the ID of the target webpage;
receiving the ID of the target webpage and target application data sent by the sharing end through a target application; and
sending the target application data to a Web application corresponding to the target webpage according to the ID of the target webpage.
